(19) United States
(12) Patent Application Publication
(10) Pub. No.: US 2021/0129006 A1
(43) Pub. Date: May 6, 2021

(54) METHODS AND APPARATUSES FOR GOLF

(71) Applicant: John NOLAN, Sparks, MD (US)

(72) Inventor: John NOLAN, Sparks, MD (US)

(21) Appl. No.: 16/673,473

(22) Filed: Nov. 4, 2019

(51) Int. Cl. A63B 69/36; A63B 57/30

(52) U.S. Cl. CPC A63B 69/3676; A63B 57/30; A63B 2069/3602; A63B 2230/62; A63B 2207/02; A63B 2220/05; A63B 2220/18; A63B 2069/3679

(57) ABSTRACT

Aspects of the present disclosure include a putting aide having a casing, a support member coupled to the casing, wherein the support member is configured to support the casing on a surface, and one or more lights coupled to the casing, wherein the one or more lights are configured to project a moveable light pattern onto the surface.

### BACKGROUND

Golf is played by many professional and amateur players. Putting is an integral part of the sport and may be practiced by players without a course or a driving range. For example, players may enjoy or practice putting in an office, at home, or other locations outside of a golf course. Players may want to putt during day time or at night. However, insufficient lighting or lack of a putting hole may limit the opportunities for the players to practice putting. Therefore, improvements in providing putting opportunities may be desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

Aspects of the present disclosure include a putting aide having a casing, a support member coupled to the casing, wherein the support member is configured to support the casing on a surface, and one or more lights coupled to the casing, wherein the one or more lights are configured to project a moveable light pattern onto the surface.

Some aspects of the present disclosure include a putting tool having a mobile device comprising a mobile processor configured to present a graphical user interface configured to receive an activation input for activating one or more lights of a putting aide and a communication interface configured to transmit an activation command signal in response to the activation input, and a putting aide comprising a communication device configured to receive the activation command signal, the one or more lights configured to project a moveable light pattern onto a surface, an aide processor configured to activate, in response to receiving the activation command signal, the one or more lights to project the moveable light pattern onto the surface.

### BRIEF DESCRIPTION OF THE DRAWINGS

The novel features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 is a combination front view and schematic diagram of an example of a putting aide in accordance with aspects of the present disclosure;

FIG. 2 is a schematic diagram of an example of an environment for using the putting aide in accordance with aspects of the present disclosure;

FIG. 3 is a combination front view and schematic diagram of another example of a putting aide in accordance with aspects of the present disclosure;

FIG. 4 is a schematic diagram of a further example of a putting aide in accordance with aspects of the present disclosure; and

FIG. 5 is a block diagram of an example of a computer system in accordance with aspects of the present disclosure.

### DETAILED DESCRIPTION

Many people enjoy the game of golf. However, playing golf requires infrastructure, such as the course (e.g., fairway and green), driving range, holes, etc., that may not be readily available to people. Further, given that golf is primarily an outdoor game, lighting and weather may impact the availability to play golf.

In an aspect of the present disclosure, a putting aide may emit a light that is projected onto a surface to simulate a golf hole. A location of the simulated golf hole may change based on changes of the projected light. In one aspect, a golfer may use a remote device to control the location of the simulated golf hole. In another aspect, a stake of the putting aide may be inserted onto a surface, such as grass. In some instances, a portion of the putting aide (e.g., the housing 102 or the support member 150) may be extendible such as being moveable between a first length and a second length. The housing 102 or the support member 150 may have concentric, telescoping members that may be removably fixed between different relative positions to define the different lengths.

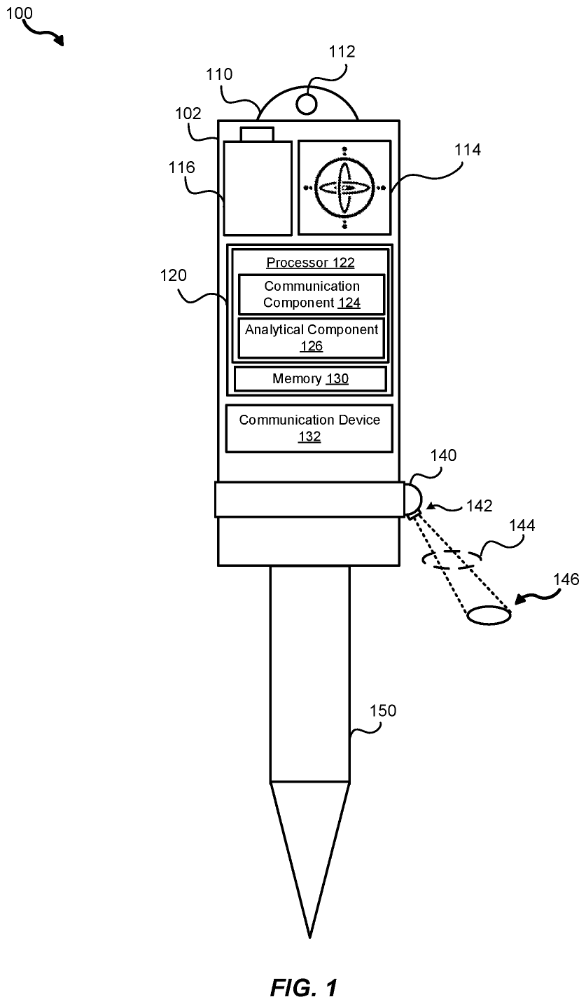

Turning to FIG. 1, in some aspects, a schematic view of a non-limiting example of a putting aide 100 configured to project a light pattern or image onto a surface, such as to simulate a golf hole. The putting aide 100 may include a housing 102 that acts as a support for the other components of the device. The putting aide 100 may include a first rotatable dome 110 having one or more photodetectors 112 for capture images and/or videos. The one or more photodetectors 112 may include one or more of visible light cameras, infra-red cameras, wide-angle cameras, or other cameras suitable for capturing still and/or moving images. The putting aide 100 may include one or more gyroscope sensors 114 for detecting an orientation of the putting aide 100. For example, if the putting aide 100 is tilted (on an slanted surface), the putting aide 100 may utilize the one or more gyroscope to measure the degree of tilt. The putting aide 100 may The putting aide 100 may include a battery 116 that provides electrical energy to other components of the putting aide 100.

In some instances, the putting aide 100 may include a controller 120 having a processor 122 and a memory 130. The processor 122 may include a communication component 124 that communicates with external devices (as discussed below). The processor 122 may include an analytical component 126 that analyzes golf swings and a trajectory and/or path of the golf ball based on the images captured by the one or more photodetectors 112. The memory 130 may include a non-transitory computer readable medium.

The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein.

The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

In certain implementations, the putting aide 100 may include a second rotatable dome 140 having one or more lights 142 that are configured to emit a light beam 144 to project a light pattern 146, such as of a simulated golf hole. The light pattern may be, for example, a round area of light (e.g., white light, natural light, or other colored lights), an image, a ring of light, or other patterns. The light pattern 146 may be projected 1 inch, 2 inches, 3 inches, 6 inches, or more from the putting aide 100. The one or more lights 142 may include light emitting diodes, fluorescent lights, incandescent lights, halogen lights, or other lights suitable for projecting a light image onto a surface. The one or more lights 142 may be moveably positioned to move the projected light image. For example, an actuator (not shown) may move an orientation of the one or more lights 142, and/or the second rotatable dome 140 to move the one or more lights 142, and therefore, the projected light pattern 146. In alternative examples, the putting aide may move the light pattern 146 by changing from projecting a first light of the one or more lights 142 at a first location to projecting a second light of the one or more lights 142 at a second location.

In some implementations, the putting aide 100 may include a support member 150, which provides a base on which the housing 102 and other components of the device may be supported above a mounting surface, such as the ground. In some implementations, the support member 150 may have the form of a stake, which may be inserted into a surface (e.g., grass) to stabilize the putting aide 100. In other implementations, the support member 150 may have the form of a stand, a base, a rack, a tripod, a mounting, or other support members that rest on or on top of the surface. For example, the support member 150 may include a stand instead of the stake for use on the ground, a floor, or any environment where it is not desired or possible for the support member 150 to penetrate the surface. In another example, the support member 150 may be in the form of a tripod with adjustable legs for use on standing the putting aide 100 on uneven terrain.

In some variations, the putting aide 100 may include a communication device 132 (e.g., wireless modem) for providing wired or wireless computer communications utilizing various protocols to send/receive electronic signals internally with respect to features and systems within the putting aide 100 and with respect to external devices. These protocols may include a wireless system utilizing RF communications (e.g., IEEE 802.11 (Wi-Fi), IEEE 802.15.1 (Bluetooth®)), a near field communication system (NFC) (e.g., ISO 13157), a local area network (LAN), a wireless wide area network (WWAN) (e.g., cellular) and/or a point-to-point system. Additionally, the communication device 132 of the putting aide 100 may be operably connected for internal computer communication via a bus (e.g., a CAN or a LIN protocol bus) to facilitate data input and output between among features and systems.

The term “operable connection,” as used herein, can include a connection by which entities are “operably connected”, is one in which signals, physical communications, and/or logical communications can be sent and/or received. An operable connection can include a physical interface, a data interface and/or an electrical interface.

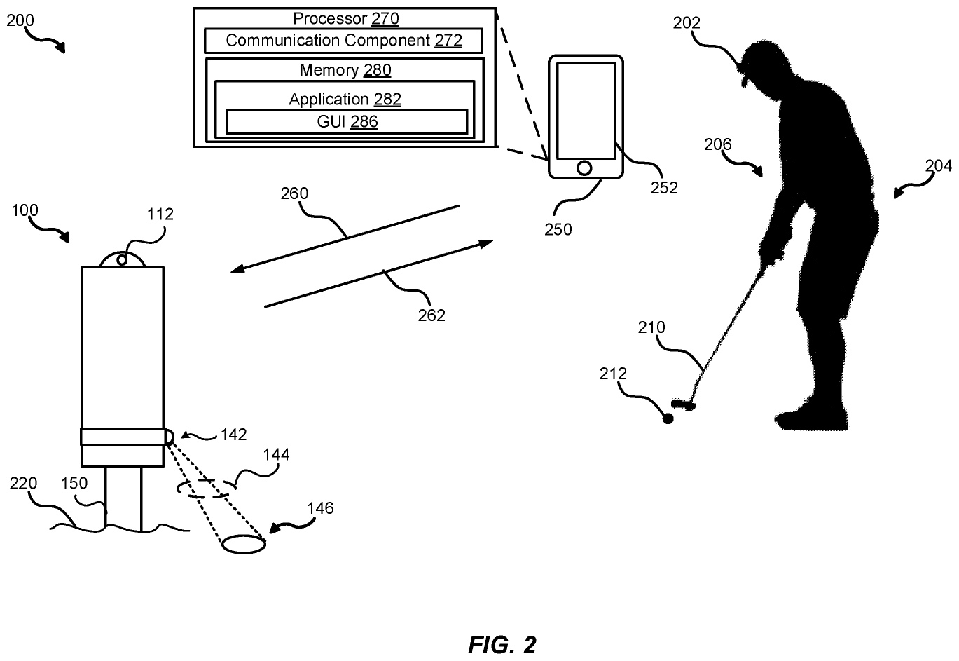

Turning now to FIG. 2, and referencing FIG. 1, in some aspects, an example of an environment 200 for using the putting aide 100 in a case where the support member 150 is a stake inserted into a surface 220, such as the ground. The putting aide 100 may project the light pattern 146, such as to define a simulated golf hole, in a vicinity of the putting aide 100 (discussed in detail below). The environment 200 may include a golfer 202 attempting to strike a golf ball 212 with a club 210 to putt the golf ball 212 into an area of the light pattern 146 of the simulated golf hole. The environment 200 may include a mobile device 250 configured to transmit a command signal 260 to the putting aide 100 to, for example, activate the one or more lights 140. The putting aide 100 may be configured to transmit a response signal 262 to the mobile device 250, for example, that includes an image or video of the golf swing.

In some implementations, the mobile device 250 may include a mobile phone, a tablet computer, a personal digital assistant, a wireless phone, a wireless device, a handheld device, a laptop computer, or other portable electronic devices capable of communicating with the camera and/or displaying a video stream. The mobile device 250 may include a processor 270 having a communication component 272 that may transmit and/or receive data from putting aide 100. The mobile device 250 may include an application 282 stored in a memory 280. When the instructions of the application 282 are executed by the processor 270, a graphical user interface (GUI) 286 allow the golfer 202 to input one or more commands for the putting aide 100 and/or receive images from the putting aide 100.

In some implementations, the mobile device 250 may include a display 252 such as a touch-sensitive display, a liquid crystal display, an active matrix display, an organic light emitting diode display, and/or a reflective display or any other display capable of displaying an image and/or a video stream.

During normal operations, in some implementations, the golfer 202 may insert the support member 150 of the putting aide 100 into the surface 220, such as a grassy surface (e.g., golf green, golf fairway, practice putting green), a dirt surface, or other suitable surfaces. The golfer 202 may input a turn-on-light command via the GUI 286 of the mobile device 250. The mobile device 250 may transmit the command signal 260 including the turn-on-light command to the putting aide 100 to instruct the putting aide 100 to activate the one or more lights 142 to project a light pattern 146 (e.g., a simulated golf hole). The one or more lights 142 of the putting aide 100 may emit a light beam 144 to project the light pattern 146 onto the surface 220. The golfer 202 may swing the club 210 (e.g., a putter) to strike the ball 212. The golfer 202 may attempt to strike the ball 212 so the ball 212 travels toward an area on the surface of the light pattern 146 that is simulating a golf hole.

In some implementations, the golfer 202 may input an adjust-light command via the GUI 286 of the mobile device 250. The mobile device 250 may transmit the command signal 260 including the adjust-light command to the putting aide 100 to instruct the putting aide 100 to adjust the one or more lights 142 to move the light pattern 146.

In a non-limiting aspect of the present disclosure, prior to swinging the club 210, the golfer 202 may input a record command via the GUI 286 of the mobile device 250. The mobile device 250 may transmit the command signal 260 including the record command to the putting aide 100 to activate the one or more photodetectors 112 to capture an image and/or record a video of the golfer 202 swinging the club 210. In one example, the one or more photodetectors 112 may use one or more of image processing or a motion sensor (not shown) to determine the starting time of the video (prior to the golfer 202 swinging the club 210), the ending time of the video (after the golfer 202 swinging the club 210), the duration of the video, and/or the timing of when to capture the image.

In some implementations, after the golfer 202 swings the club 210, the communication component 124 and/or the communication device 132 of the putting aide 100 may transmit the response signal 262 including the captured image and/or the recorded video to the mobile device 250. The golfer 202 may view the captured image and/or the recorded video on the display 252 of the mobile device 250.

In some aspects, the analytical component 126 of the putting aide 100 may analyze a golf stance 204 of the golfer 202 and/or the golf swing 206 of the golfer 202 based on the captured image and/or the recorded video. For example, after analyzing the golf stance 204, the analytical component 126 may determine that golfer 202 should adjust the golf stance 204 by standing up more straight. In response, the communication component 124 and/or the communication device 132 of the putting aide 100 may transmit the response signal 262 including the recommendation (i.e., standing up more straight) to the mobile device 250. Other examples of recommendations may include changing from a face balanced putter to a toe balanced putter, reducing the swing of the club 210, etc.

In optional aspects, the putting aide 100 may utilize information from the one or more gyroscope sensors 114 to determine the gradient of the surface 220. The analytical component 126 provide recommendations based on the gradient of the surface 220.

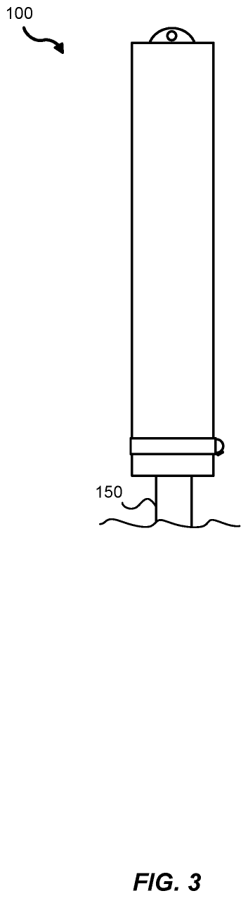

Turning now to FIG. 3, in some variations, an example of the putting aide 100 with the housing 102 in an extended position. In this aspect, the housing 102 includes one or more movable members that may be relatively fixed at different positions to define a variable length housing 102, e.g., extendable from a retracted length (e.g., 10 centimeters (cm), 20 cm, 50 cm, 100 cm, or longer) to an extended length (e.g., 50 cm, 100 cm, 120 cm, 150 cm, or longer). In some instances, the golfer 202 may extend the support member 150 of the putting aide 100 when putting from a long distance (e.g., 5 meters (m), 10 m, 15 m, or longer) and/or when a putting surface includes hills that may impair the golfer's view of the light pattern (and hence the raised putting aide 100 may provide a target for the golfer). In certain implementations, the housing 102 may be telescopically extended or retracted. In other instances, the support member 150 may be extendible (not shown in FIG. 3).

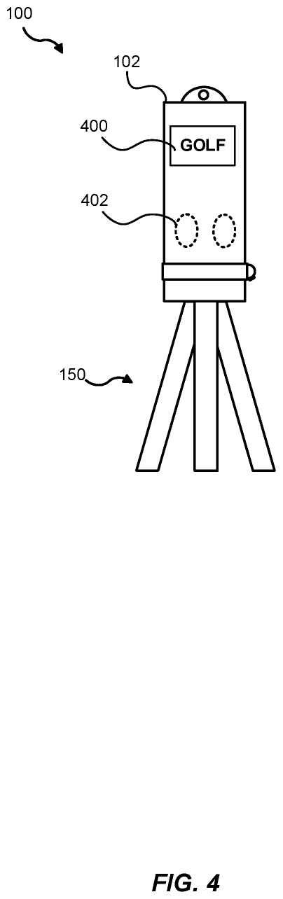

Turning now to FIG. 4, and referencing FIG. 2, in some variations, an example of the putting aide 100 may further include a display 400 configured to output alphanumeric characters, symbols, logos, pictures, or other images. For example, the display 400 may show a team logo associated with a team of the golfer 202. The display 400 may include any type of display device, such as a pattern of one of more lights, a liquid crystal device, a light emitting diode device, etc. The support member 150 shown in FIG. 4 may be a stand or a tripod.

In an aspect of the present disclosure, the putting aide 100 may optionally include illumination lights 402 (e.g., LED lights) that illuminate at night to increase the visibility of the putting aide 100.

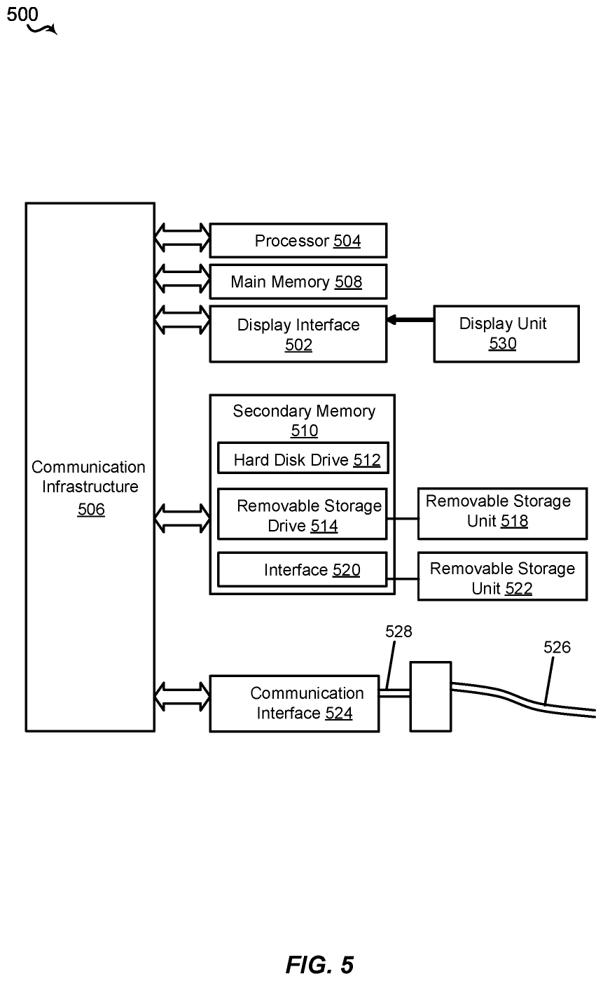

Aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. For example, the controller 120 and or the mobile device 250 may be implemented as the computer system 500. An example of such the computer system 500 is shown in FIG. 5.

The computer system 500 includes one or more processors, such as processor 504. The processor 504 is connected to a communication infrastructure 506 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 500 may include a display interface 502 that forwards graphics, text, and other data from the communication infrastructure 506 (or from a frame buffer not shown) for display on a display unit 530. Computer system 500 also includes a main memory 508, preferably random access memory (RAM), and may also include a secondary memory 510. The secondary memory 510 may include, for example, a hard disk drive 512, and/or a removable storage drive 514, representing a floppy disk drive, a magnetic tape drive, an optical disk drive, a universal serial bus (USB) flash drive, etc. The removable storage drive 514 reads from and/or writes to a removable storage unit 518 in a well-known manner. Removable storage unit 518 represents a floppy disk, magnetic tape, optical disk, USB flash drive etc., which is read by and written to removable storage drive 514. As will be appreciated, the removable storage unit 518 includes a computer usable storage medium having stored therein computer software and/or data.

Alternative aspects of the present disclosures may include secondary memory 510 and may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and the removable storage unit 522 and interface 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528, which may be electronic, electromagnetic, optical or other signals capable of being received by communications interface 524. These signals 528 are provided to communications interface 524 via a communications path (e.g., channel) 526. This path 526 carries signals 528 and may be implemented using wire or cable, fiber optics, a telephone line, a cellular link, an RF link and/or other communications channels. In this document, the terms “computer program medium” and “computer usable medium” are used to refer generally to media such as a removable storage unit 518, a hard disk installed in hard disk drive 512, and signals 528. These computer program products provide software to the computer system 500. Aspects of the present disclosures are directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features in accordance with aspects of the present disclosures, as discussed herein. In particular, the computer programs, when executed, enable the processor 504 to perform the features in accordance with aspects of the present disclosures. Accordingly, such computer programs represent controllers of the computer system 500.

In an aspect of the present disclosures where the method is implemented using software, the software may be stored in a computer program product and loaded into computer system 500 using removable storage drive 514, hard disk drive 512, or the interface 520. The control logic (software), when executed by the processor 504, causes the processor 504 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

1. A putting aide, comprising:
a housing;
a support member coupled to and extending from the housing, wherein the support member is configured to support the housing on a surface; and
one or more lights coupled to the housing, wherein the one or more lights are configured to project a moveable light pattern onto the surface, wherein the moveable light pattern simulates a golf hole.

2. The putting aide of claim 1, further comprising:
a communication device mounted on the housing and configured to receive a command signal; and
a processor mounted on the housing in communication with the communication device and configured to activate, in response to the command signal, the one or more lights to project the moveable light pattern on the surface.

3. The putting aide of claim 2, wherein the processor is further configured to receive a second command signal to move the one or more lights to move the moveable light pattern from a first location to a second location.

4. The putting aide of claim 1, further comprising a photodetector mounted on the housing and configured to capture an image or a video associated with a golf swing.

5. The putting aide of claim 4, further comprising a communication device configured to transmit at least one of the image or the video.

6. The putting aide of claim 1, further comprising one or more gyroscopes mounted on the housing and configured to measure a gradient of the surface.

7. The putting aide of claim 1, wherein the support member comprises a stake configured to penetrate the surface to support the housing.

8. The putting aide of claim 1, wherein the support member comprises a stand configured to be set on the surface to support the housing.

9. The putting aide of claim 1, further comprising a battery mounted on the housing and configured to provide electrical energy to the putting aide.

10. The putting aide of claim 1, further comprising a display mounted on the housing and configured to display at least one of an alphanumeric character, a symbol, a logo, a graphic, an image, a video, or a picture.

11. The putting aide of claim 1, further comprising an illumination light mounted to the housing.

12. The putting aide of claim 1, wherein the housing is extendible.

13. A putting tool, comprising:
a mobile device comprising:
a mobile processor configured to present a graphical user interface configured to receive an activation input for activating one or more lights of a putting aide; and
a communication interface configured to transmit an activation command signal in response to the activation input; and
a putting aide comprising:
a communication device configured to receive the activation command signal;
the one or more lights configured to project a moveable light pattern onto a surface, wherein the moveable light pattern simulates a golf hole; and
an aide processor configured to activate, in response to receiving the activation command signal, the one or more lights to project the moveable light pattern onto the surface.

14. The putting tool of claim 13, wherein:
the graphical user interface is further configured to receive a moving input;
the communication interface is further configured to transmit a moving command signal in response to the moving input;
the communication device is further configured to receive the moving command signal; and
the aide processor is further configured to cause the one or more lights to move the moveable light pattern.

15. The putting tool of claim 13, wherein:
the graphical user interface is further configured to receive a record input;
the communication interface is further configured to transmit a record command signal in response to the record input;
the communication device is further configured to receive the record command signal;
wherein the putting aide further comprises a photodetector configured to capture an image or record a video of a golf swing; and
the aide processor is further configured to activate the photodetector to capture the image or record the video of the golf swing.

16. The putting tool of claim 15, wherein the communication device is further configured to transmit the image or the video to the communication interface.

17. The putting tool of claim 13, wherein the putting aide further comprises a support member configured to support the putting aide on a surface.

18. The putting tool of claim 17, wherein the one or more lights are further configured to project the moveable light pattern onto the surface to simulate a golf hole.

19. The putting tool of claim 17, wherein the support member is a stake configured to penetrate the surface to support the putting aide.

20. The putting tool of claim 17, wherein the support member is a stand configured to be set on the surface to support the putting aide.
